(19) United States
(12) Patent Application Publication
(10) Pub. No.: US 2025/0372679 A1
(43) Pub. Date: Dec. 4, 2025

(54) APPARATUS FOR VEHICLE CONTROL AND METHOD THEREOF

(71) Applicants: Hyundai Motor Company, Seoul (KR); Kia Corporation, Seoul (KR)

(72) Inventors: Ho Seung Jang, Hwaseong-Si (KR); Min Gu Park, Hwaseong-Si (KR); Jun Su Lee, Hwaseong-Si (KR)

(21) Appl. No.: 18/952,382

(22) Filed: Nov. 19, 2024

(30) Foreign Application Priority Data
May 29, 2024 (KR) 10-2024-0070262

(51) Int. Cl. H01M 8/0438; B60L 58/31; H01M 8/04225; H01M 8/04746; H01M 8/04858

(52) U.S. Cl. CPC H01M 8/04425; B60L 58/31; H01M 8/04225; H01M 8/04432; H01M 8/04776; H01M 8/04873; H01M 2250/20

(57) ABSTRACT

An apparatus for controlling a vehicle is introduced. The apparatus may comprise a fuel cell, a sensor, an air compressor, and a processor configured to drive, based on an input indicating that the vehicle's ignition is on, the air compressor at a specified revolutions per minute (RPM) and control an air flow to prevent from entering the fuel cell, determine, based on sensor information from the sensor, whether a flow of air, driven by the air compressor, entering the vehicle from an outside is within a specified flow range, wherein the specified flow range may comprise a target flow, and change, based on the flow of the air entering the vehicle being outside the specified flow range, a parameter to adjust an oscillation of an output of the vehicle, wherein the output of the vehicle corresponds to the specified RPM.

### CROSS-REFERENCE TO RELATED APPLICATION

This application claims the benefit of priority to Korean Patent Application No. 10-2024-0070262, filed in the Korean Intellectual Property Office on May 29, 2024, the entire contents of which are incorporated herein by reference.

### TECHNICAL FIELD

The present disclosure relates to an apparatus for vehicle control and a method thereof and, more particularly, to technology for diagnosing the oscillation of an output.

### BACKGROUND

The matters described in this Background section are only for enhancement of understanding of the background of the disclosure, and should not be taken as acknowledgement that they correspond to prior art already known to those skilled in the art.

Depending on the shape of an air intake system associated with a fuel cell system (e.g., power module complete (PMC)), the differential pressure of the air intake system may be different. For example, if the differential pressure of the air intake system is excessive, oscillation of a flow may occur. If the oscillation of a flow occurs, the oscillation of the output of a fuel cell may occur. In the fuel cell system itself, logic is being developed to compensate for the oscillation of a flow and/or the oscillation of an output for the air intake system according to the shape of the air intake system. However, because the fuel cell system may be driven passively according to the sequence of a vehicle, it may be relatively difficult to define a separate diagnostic mode for diagnosing the oscillation of a flow and/or the oscillation of an output. Accordingly, there is a need to discuss research for diagnosing (or correcting) the oscillation of flow and/or the oscillation of an output during vehicle starting sequence or while a vehicle is running, without using a separate diagnostic mode.

### SUMMARY

According to the present disclosure, an apparatus for controlling a vehicle, the apparatus may comprise a fuel cell, a sensor, an air compressor, and a processor configured to drive, based on an input indicating that the vehicle's ignition is on, the air compressor at a specified revolutions per minute (RPM) and control an air flow to prevent from entering the fuel cell, determine, based on sensor information from the sensor, whether a flow of air, driven by the air compressor, entering the vehicle from an outside is within a specified flow range, wherein the specified flow range may comprise a target flow, and change, based on the flow of the air entering the vehicle being outside the specified flow range, a parameter to adjust an oscillation of an output of the vehicle, wherein the output of the vehicle corresponds to the specified RPM.

The apparatus, wherein the processor is further configured to after the vehicle's ignition is completed, determine the output of the vehicle, determine whether the output of the vehicle is within a specified output range, change, based on the output of the vehicle being outside the specified output range, the parameter, and control, based on the changed parameter, the vehicle.

The apparatus, wherein the processor is further configured to stop, based on the output of the vehicle being within the specified output range, changing the parameter.

The apparatus, wherein the processor is further configured to set, based on the output of the vehicle being outside the specified output range, the parameter to a minimum value for minimizing the oscillation.

The apparatus, wherein the processor is further configured to control the vehicle by outputting, based on the changed parameter, a voltage corresponding to the output from the fuel cell.

The apparatus, wherein the processor is further configured to drive, based on the flow of the air entering the vehicle being within the specified flow range, the air compressor at another RPM different from the specified RPM.

The apparatus, wherein the processor is further configured to control the air to be prevented from entering the fuel cell through an air bypass.

The apparatus, wherein the processor is further configured to determine the parameter, wherein the parameter corresponds to the specified RPM, and change, based on the flow of the air being outside the specified flow range, the parameter.

The apparatus, wherein the processor is further configured to supply hydrogen to the fuel cell in the state where air from the air compressor is blocked from entering the fuel cell.

The apparatus, wherein the parameter represents a relationship between the output of the vehicle and a voltage of the fuel cell, wherein the voltage is applied to generate the output of the vehicle.

According to the present disclosure, a method performed by an apparatus for controlling a vehicle, the method may comprise driving, based on an input indicating that the vehicle's ignition is on, an air compressor at a specified revolutions per minute (RPM) and controlling an air flow to prevent from entering a fuel cell, determining, based on sensor information from a sensor, whether a flow of air entering the vehicle from an outside is within a specified flow range, wherein the specified flow range may comprise a target flow, and changing, based on the flow of the air entering the vehicle being outside the specified flow range, a parameter to adjust an oscillation of an output of the vehicle, wherein the output of the vehicle corresponds to the specified RPM.

The method, wherein the changing of the parameter may comprise after the vehicle's ignition is completed, determining the output of the vehicle, determining whether the output of the vehicle is within a specified output range, changing, based on the output of the vehicle being outside the specified output range, the parameter, and controlling, based on the changed parameter, the vehicle.

The method, wherein the determining whether the output of the vehicle is within the specified output range may comprise stopping, based on the output of the vehicle being within the specified output range, changing the parameter.

The method, wherein the determining whether the output of the vehicle is within the specified output range may comprise setting, based on the output of the vehicle being outside the specified output range, the parameter to a minimum value for minimizing the oscillation.

The method, wherein the controlling the vehicle may comprise controlling the vehicle by outputting, based on the changed parameter, a voltage corresponding to the output from the fuel cell.

The method, wherein the determining whether the flow of the air flowing into the vehicle is within the specified flow range may comprise driving, based on the flow of the air entering the vehicle being within the specified flow range, the air compressor at another RPM different from the specified RPM.

The method, wherein the driving the air compressor may comprise controlling the air to be prevented from entering the fuel cell through an air bypass.

The method, wherein the changing the parameter may comprise determining the parameter, wherein the parameter corresponds to the specified RPM, and changing, based on the flow of the air entering the vehicle being outside the specified flow range, the parameter.

The method, wherein the driving the air compressor may comprise supplying hydrogen to the fuel cell in a state where air from the air compressor being blocked from entering the fuel cell.

The method, wherein the parameter represents a relationship between the output of the vehicle and a voltage of the fuel cell, wherein the voltage is applied to generate the output of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram related to a vehicle control apparatus according to an example of the present disclosure;

FIG. 2 shows an example of a block diagram of a fuel cell system related to a fuel cell included in the vehicle control apparatus according to an example of the present disclosure;

FIG. 3 shows an example of steps for the vehicle control apparatus according to an example of the present disclosure to control the fuel cell system;

FIG. 4 shows an example of a state for explaining steps in which the vehicle control apparatus according to an example of the present disclosure supplies hydrogen to the fuel cell;

FIG. 5 shows an example of a state for explaining steps in which the vehicle control apparatus according to an example of the present disclosure performs a starting purge;

FIG. 6 shows an example of a state for explaining steps in which the vehicle control apparatus according to an example of the present disclosure supplies air to the fuel cell;

FIG. 7 shows an example of a flowchart for explaining an operation in which the vehicle control apparatus according to an example of the present disclosure changes a parameter;

FIG. 8 shows an example of a graph representing the output of a vehicle identified by the vehicle control apparatus according to an example of the present disclosure changing a parameter;

FIG. 9 shows an example of a flowchart representing the operation of the vehicle control apparatus according to an example of the present disclosure;

FIG. 10 shows an example of a flowchart representing a vehicle control method according to an example of the present disclosure; and

FIG. 11 shows an example of a computing system related to the vehicle control apparatus or the vehicle control method according to an example of the present disclosure.

### DETAILED DESCRIPTION

Hereinafter, some examples of the present disclosure will be described in detail through example drawings. When adding reference numerals to components in each drawing, it should be noted that identical components are given the same reference numerals as much as possible even if they are shown in different drawings. Additionally, when explaining an example of the present disclosure, if it is determined that a detailed description of a related known configuration or function impedes understanding of the example of the present disclosure, detailed description thereof is omitted.

In describing the components of the present disclosure, terms such as first, second, A, B, (a), (b), etc. may be used. These terms are only used to distinguish a component from other components, and the nature, sequence, or order of the corresponding component is not limited by the terms. Additionally, unless otherwise defined, all terms used herein, including technical or scientific terms, have the same meaning as commonly understood by those skilled in the art in the technical field to which the present disclosure pertains. Terms defined in commonly used dictionaries should be interpreted as having meanings consistent with meanings in the context of the related technology, and should not be interpreted in an idealized or excessively formal sense unless clearly defined in the present application.

The term “module” used in various examples of the present disclosure may include a unit implemented in hardware, software, or firmware, and may be used interchangeably with a term such as logic, a logic block, a part, or a circuit. A module may be an integrated part, or a minimum unit of parts or a part thereof that performs one or more functions. In an example, a module may be implemented in the form of an application-specific integrated circuit (ASIC). According to various examples, operations performed by a module, a program, or other components may be executed sequentially, in parallel, or iteratively, or one or more of the operations may be executed in a different order, omitted, or one or more other operations may be added thereto.

Various examples of the present disclosure may be implemented as software (e.g. a program) that includes one or more instructions stored in a storage medium (e.g., internal memory or external memory) that may be read by a machine (e.g., a vehicle control apparatus 100). For example, a processor (e.g., a processor 110) of the machine (e.g., the vehicle control apparatus 100) may call at least one instruction among one or more stored instructions from the storage medium and execute the instruction. This allows the machine to be operated to perform at least one function according to at least one instruction called. One or more instructions may include a code generated by a compiler or a code that may be executed by an interpreter. The storage medium that may be read by a machine may be provided in the form of a non-transitory storage medium. Here, ‘non-transitory’ only means that the storage medium is a tangible device and does not include signals (e.g., electromagnetic waves). This term does not distinguish between data being semi-permanently stored in the storage medium and data being stored temporarily therein.

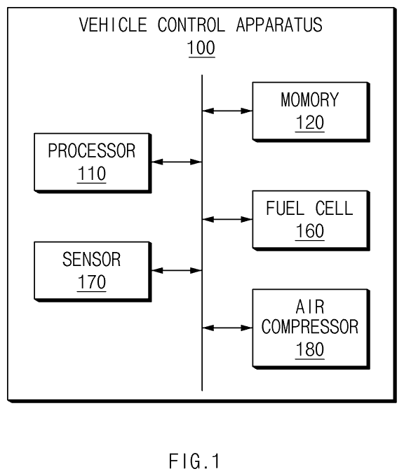

Hereinafter, examples of the present disclosure will be described in detail with reference to FIGS. 1 to 11.

FIG. 1 shows an example of a block diagram related to a vehicle control apparatus according to an example of the present disclosure.

Referring to FIG. 1, the vehicle control apparatus 100 according to an example of the present disclosure may be implemented inside or outside a vehicle, and some of components apparatus 100 may be included in the vehicle control implemented inside or outside the vehicle. At this time, the vehicle control apparatus 100 may be formed integrally with internal control units of the vehicle, or may be implemented as a separate apparatus and may be connected to the control units of the vehicle by a separate connection means. For example, the vehicle control apparatus 100 may further include components not shown in FIG. 1.

The vehicle control apparatus 100 according to an example may include at least one of the processor 110, a memory 120, a fuel cell 160, a sensor 170 (e.g., a temperature sensor for determining the temperature, a flow sensor for measuring the air or gas flow, a pressure sensor for detecting pressure, an output sensor for monitoring the vehicle's power output, or a hydrogen sensor for detecting hydrogen concentration or flow within the fuel cell system, etc.), or an air compressor 180. The processor 110, the memory 120, the fuel cell 160, the sensor 170, and the air compressor 180 are electrically and/or operably coupled with each other by an electronic component including a communication bus. Hereinafter, the operable combination of many pieces of hardware with each other may mean that a direct connection or an indirect connection between the hardware is established by wire or wirelessly so that a second hardware is controlled by a first hardware among the hardware. Although shown based on different blocks, the example is not limited thereto, and some of the hardware of FIG. 1 (e.g., at least some of the processor 110, the memory 120, and a communication circuit (not shown)) may be included in a single integrated circuit, such as a system on a chip (SoC).

The processor 110 of the vehicle control apparatus 100 according to an example may include hardware components for processing data based on one or more instructions. The hardware components for processing data may include, for example, an arithmetic and logic unit (ALU), a floating point unit (FPU), a field programmable gate array (FPGA), a central processing unit (CPU), a micro controller unit (MCU), and/or an application processor (AP). The processor 110 may include one or more processors. For example, the processor 110 may have the structure of a multi-core processor including dual core, quad core, hexa core, or octa core.

The memory 120 of the vehicle control apparatus 100 according to an example may include a hardware component for storing data and/or instructions input and/or output to the processor 110. The memory 120 may include, for example, a volatile memory such as random-access memory (RAM) and/or a non-volatile memory such as read-only memory (ROM). For example, the volatile memory may include at least one of dynamic RAM (DRAM), static RAM (SRAM), cache RAM, or pseudo SRAM (PSRAM). For example, the non-volatile memory may include at least one of programmable ROM (PROM), erasable PROM (EPROM), electrically erasable PROM (EEPROM), flash memory, hard disk, compact disk, or an embedded multimedia card (eMMC). The processor 110 and/or the memory 120 may be related to a fuel cell system for controlling a fuel cell and/or managing a temperature thereof.

The fuel cell 160 (or a fuel cell stack) of the vehicle control apparatus 100 according to an example may include an anode and a cathode. For example, the anode of the fuel cell 160 may be supplied with hydrogen, causing oxidation of the hydrogen. For example, the cathode of the fuel cell 160 may be supplied with oxygen, causing reduction of the oxygen. For example, the fuel cell 160 may include components for generating electricity by causing the reactions of hydrogen and oxygen. However, the examples of the present disclosure are not limited to what has been described above.

The air compressor 180 of the vehicle control apparatus 100 according to an example may include an air processing system (APS) or an air intake system for supplying air (or oxygen) to the fuel cell 160. The air processing system (or the air intake system) may include a compressor for compressing and introducing air from the outside of the vehicle control apparatus 100 (or the outside of a vehicle), a filter, a flow sensor for determining the air flow of incoming air, and/or humidifier.

The sensor 170 of the vehicle control apparatus 100 according to an example may generate electrical information that may be processed by the processor 110 and/or the memory 120 of the vehicle control apparatus 100 from non-electrical information related to the vehicle control apparatus 100. For example, the vehicle control apparatus 100 may measure a temperature associated with the fuel cell system and/or a flow associated with the fuel cell system by using the sensor 170. The sensor 170 may include one or more sensors. For example, the sensor 170 may include a temperature sensor for determining a temperature inside the vehicle control apparatus 100, a flow sensor for determining the flow of air, a pressure sensor for determining pressure inside the vehicle control apparatus 100, and/or an output sensor for determining the output of a vehicle.

For example, the output of a vehicle may include the output of the fuel cell 160 that is used by the vehicle control apparatus 100 (or the fuel cell 160) to generate the output of the vehicle.

In an example, the vehicle control apparatus 100 may identify a flow value indicating the flow of air flowing into a vehicle from the air compressor 180 by using the sensor 170. In an example, the vehicle control apparatus 100 may identify an output value indicating the output of a vehicle by using the sensor 170. Examples of a flow value may comprise the airflow rate (liters per second or cubic meters per minute), the mass flow rate (kilograms per second), the pressure differential (Pascals or bar), the velocity of airflow (meters per second), or the air density or temperature-adjusted flow rate.

For example, the vehicle control apparatus 100 may identify oscillation of a flow value according to the shape of the air intake system associated with the air compressor 180. Examples of oscillation of a flow value may comprise fluctuations in airflow rate (liters per second or cubic meters per minute), variations in mass flow rate (kilograms per second), pressure fluctuations (Pascals or bar), air velocity changes (meters per second), and temperature-related flow instability due to air density variations.

For example, if the differential pressure of the air intake system is relatively excessive, the oscillation of a flow may occur, so the vehicle control apparatus 100 may identify the oscillation of a flow value.

For example, if the oscillation of a flow occurs, the vehicle control apparatus 100 may identify the oscillation of the output of a vehicle (or the output of a fuel cell) caused by the oscillation of the flow. The oscillation of the output of the vehicle outside a specified output range may indicate the instability of the output of the fuel cell. The vehicle control apparatus 100 may adjust parameters to reduce the oscillation of the output of the vehicle to prevent the instability of the output of the fuel cell.

The vehicle control apparatus 100 according to an example may drive the air compressor 180 based on specified revolutions per minute (RPM) while blocking air from entering the fuel cell 160 from the air compressor 180 in response to an input indicating the ignition-on of a vehicle.

The vehicle control apparatus 100 according to an example may identify, through the sensor 170, whether the flow of air flowing into the vehicle from the outside exceeds a target flow (or whether the flow of air is outside a specified flow range including the target flow) based on the driving of the air compressor 180. Examples of a target flow may comprise the optimal airflow rate for efficient engine operation, the airflow rate used for proper combustion, the cooling airflow rate (cubic meters per minute), the minimum airflow rate for system activation, or the airflow rate to prevent pressure buildup in the intake system. For example, the vehicle control apparatus 100 may identify whether the air flow is within the specified flow range. Whether the air flow is within the specified flow range may include whether the amplitude of the air flow is within the specified flow range. Examples of a specified flow range may comprise the airflow rate range for optimal engine efficiency (e.g., 10 to 20 liters per second), the tolerable airflow fluctuation range (e.g., +5% of the target airflow), the safe airflow range for component protection (e.g., 15 to 25 cubic meters per minute), the airflow range to maintain proper air-to-fuel ratio (e.g., 12 to 18 cubic meters per minute), or the range for stable system startup (e.g., 5 to 15 liters per second).

The vehicle control according to an example may change a parameter to reduce the oscillation of the output of a vehicle, which corresponds to a specified RPM, if the flow of air flowing into the vehicle from the outside exceeds a target flow. For example, the parameter may represent a relationship between the output of the vehicle and the voltage of the fuel cell to generate the output of the vehicle. For examples, a parameter may comprise an air compressor speed (e.g., RPM), a fuel cell voltage, a P Gain of a proportional-integral (PI) controller, an airflow rate threshold, and a hydrogen supply rate, some or all of which may be adjusted to reduce oscillations and stabilize vehicle output. For example, the vehicle control apparatus 100 may stop changing the parameter if the flow of air flowing into the vehicle does not exceed the target flow. However, the present disclosure is not limited thereto. For example, the vehicle control apparatus 100 may drive the air compressor based on a different specified RPM distinct from the specified RPM if the flow of air flowing into the vehicle does not exceed the target flow.

For example, the vehicle control apparatus 100 may obtain a voltage (or an output) generated from the fuel cell 160 (or the fuel cell system) to obtain the output of a vehicle. For example, the vehicle control apparatus 100 may obtain a voltage generated from the fuel cell 160 by using a proportional-integral (PI) controller. For examples, the PI controller may perform voltage regulation for stable fuel cell output, air compressor speed control, fuel cell temperature control, pressure control in the fuel cell system, or hydrogen supply regulation to maintain target performance levels.

For example, the vehicle control apparatus 100 may, by using the PI controller, identify an error between an output (or a target output) used to obtain the output of a vehicle and a fuel cell output generated from the fuel cell 160. The vehicle control apparatus 100 may determine the target voltage of the fuel cell 160 by using an error and a parameter (e.g., a parameter to reduce the oscillation of the output of the vehicle). For example, the operation of the vehicle control apparatus 100 using the PI controller to determine the target voltage of the fuel cell 160 by using an error and a parameter may be referred to as ‘P’ control. The parameter, in terms of ‘P’ control, may be referred to as a ‘P’ control parameter or a ‘P’ control gain.

For example, since the vehicle control apparatus 100 determines a target voltage by multiplying an error by a parameter, the parameter may be related to a gain.

For example, the vehicle control apparatus 100 may determine the target voltage of the fuel cell 160 by multiplying the integral value of an error by another parameter by using the PI controller. An operation in which the vehicle control apparatus 100 determines the target voltage of the fuel cell 160 by multiplying the integral value of an error by another parameter by using the PI controller may be referred to as ‘I’ control. The anther parameter, in terms of ‘I’ control, may be referred to as an ‘I’ control parameter or an ‘I’ control gain.

For example, ‘P’ control may have the characteristic of being able to reach a target output from an output of the fuel cell relatively faster than ‘I’ control. ‘I’ control may have the characteristic of reducing a steady-state error relative to ‘P’ control. However, the present disclosure is not limited thereto.

The vehicle control apparatus 100 according to an example may identify the output of a vehicle corresponding to a specified RPM after start-up of the vehicle is completed. For example, the vehicle control apparatus 100 may identify whether the output of the vehicle is within a specified output range (e.g., an output range including a target output).

For example, the vehicle control apparatus 100 may control a vehicle by using a changed parameter if the output of the vehicle corresponding to the specified RPM is within the specified output range.

For example, the vehicle control apparatus 100 may repeatedly reduce the parameter based on a specified number of times if the output of a vehicle is outside the specified output range. The specified number of times may include a preset value. For example, the vehicle control apparatus 100 may set the parameter to a minimum value if the output of the vehicle is outside the specified output range. The minimum value may include a value set for normal operation of feedback control (e.g., an operation performed by the vehicle control apparatus 100 using the PI controller).

The vehicle control apparatus 100 according to an example as described above may identify an output to be obtained from the fuel cell 160 by using the PI controller. The vehicle control apparatus 100 may calibrate an output to be obtained from the fuel cell 160 independently of the shape of the air intake system. For example, the vehicle control apparatus 100 may calibrate an output to be obtained from the fuel cell 160 in response to the starting of a vehicle, without using a diagnostic mode to diagnose the output to be obtained from the fuel cell 160. The vehicle control apparatus 100 may identify an error between an output used to obtain the output of a vehicle and a fuel cell output generated from the fuel cell 160 by using the PI controller. The vehicle control apparatus 100 may calibrate an output to be obtained from the fuel cell 160 by changing a parameter related to the error (e.g., a ‘P’ control parameter). The vehicle control apparatus 100 may compensate for the output command value of a vehicle by using the changed parameter. The vehicle control apparatus 100 may control the vehicle by compensating for the output command value of the vehicle. The vehicle control apparatus 100 may reduce the oscillation of the output of the vehicle by controlling the vehicle. The vehicle control apparatus 100 may control the vehicle more stably by reducing the oscillation of the output of the vehicle.

For example, the vehicle control apparatus 100 calibrates an output to be obtained from the fuel cell 160 in response to the starting of the vehicle without using a diagnostic mode to diagnose an output to be obtained from the fuel cell 160, thereby reducing software development man-hours related to the vehicle control apparatus 100. For example, the vehicle control apparatus 100 may control the output of a vehicle by tuning a parameter after the fuel cell system is mounted on the vehicle.

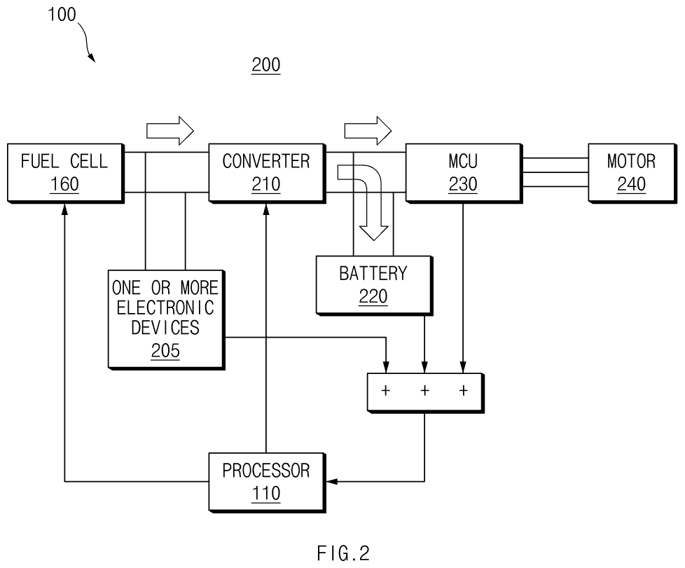

FIG. 2 shows an example of a block diagram of a fuel cell system related to a fuel cell included in the vehicle control apparatus according to an example of the present disclosure. The vehicle control apparatus 100 of FIG. 2 may be referenced to the vehicle control apparatus 100 of FIG. 1. Referring to FIG. 2, an example 200 of the fuel cell system is shown.

Referring to FIG. 2, in the example 200, the fuel cell system may include the fuel cell 160, a converter 210, one or more electronic devices 205, the processor 110, a battery 220, a micro control unit (MCU) 230, and/or a motor 240.

For example, the converter 210 may include a fuel cell dc-dc converter (FDC). For example, the one or more electronic devices 205 may include the air compressor 180 of FIG. 1. The one or more electronic devices 205 may include electronic devices (or hardware components) related to the fuel cell system. For example, the processor 110 may include a fuel cell control unit (FCU) in relation to the fuel cell system.

The processor 110 of the vehicle control apparatus 100 according to an example may obtain a request to drive a vehicle from the MCU 230 and/or the one or more electronic devices 205. The request may include information indicating an output used from the fuel cell 160 to obtain the output of the vehicle.

For example, the processor 110 of the vehicle control apparatus 100 may obtain a target voltage through the converter 210 by using information indicating the target voltage for obtaining the output, based on obtaining the request.

For example, the vehicle control apparatus 100 may determine a target voltage by using the PI controller. For example, the vehicle control apparatus 100 may identify a target voltage by using a parameter related to an error between an output and a fuel cell output, based on the execution of the PI controller.

For example, the processor 110 of the vehicle control apparatus 100 may obtain a target current through the fuel cell 160 by using information indicating the target current to obtain a target output. For example, the vehicle control apparatus 100 (or the processor 110) may identify a target voltage and a target current, based on information indicating a relationship between a voltage and a current according to the performance of the fuel cell (e.g., a current-voltage characteristic curve).

The vehicle control apparatus 100 according to an example as described above may identify the output of a vehicle according to the target current and the target voltage through the sensor. The vehicle control apparatus 100 may compensate a parameter to reduce the oscillation of the output of a vehicle if the oscillation of the output of the vehicle exceeding a specified range is identified. For example, the vehicle control apparatus 100 may obtain the stability of the output of the vehicle by compensating the parameter by using the PI controller.

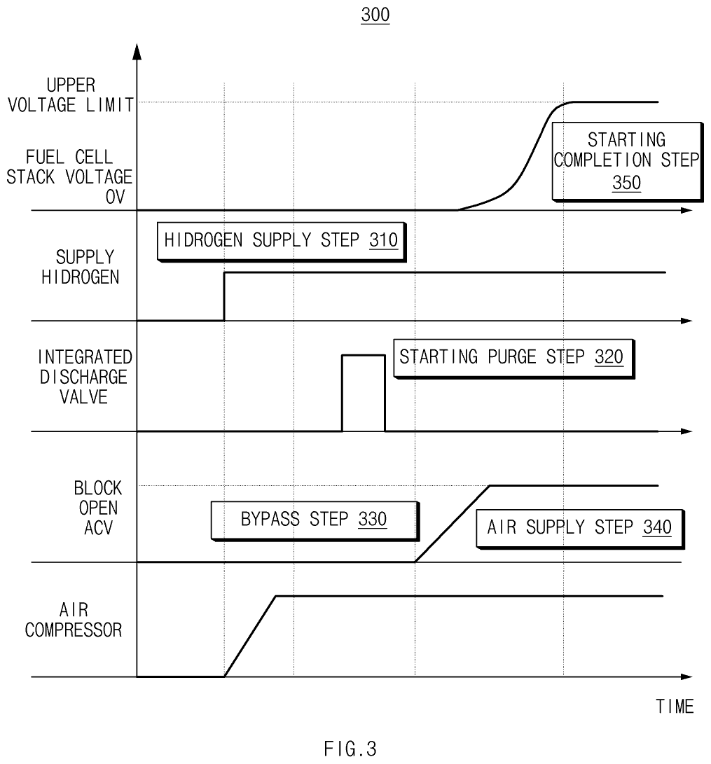

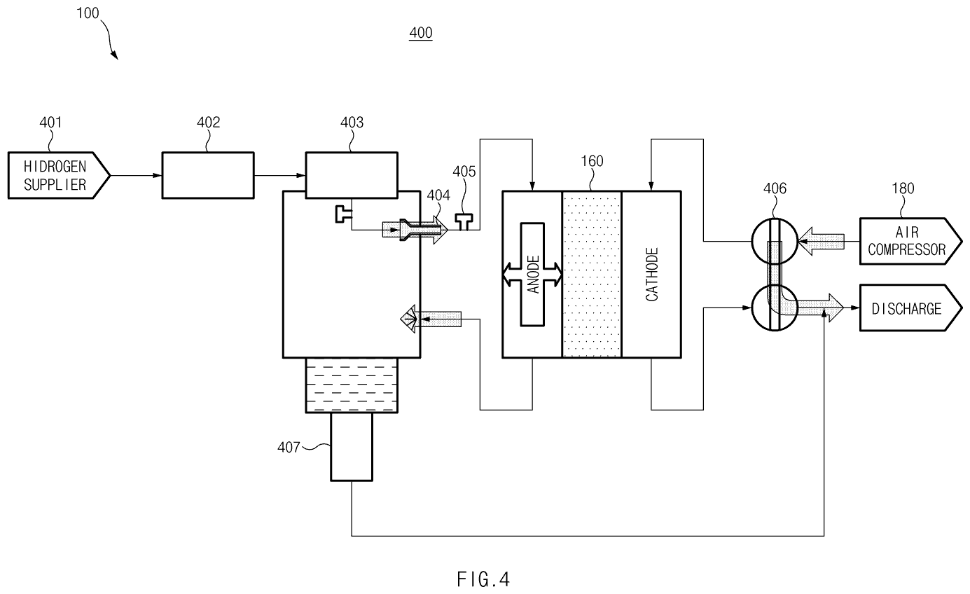

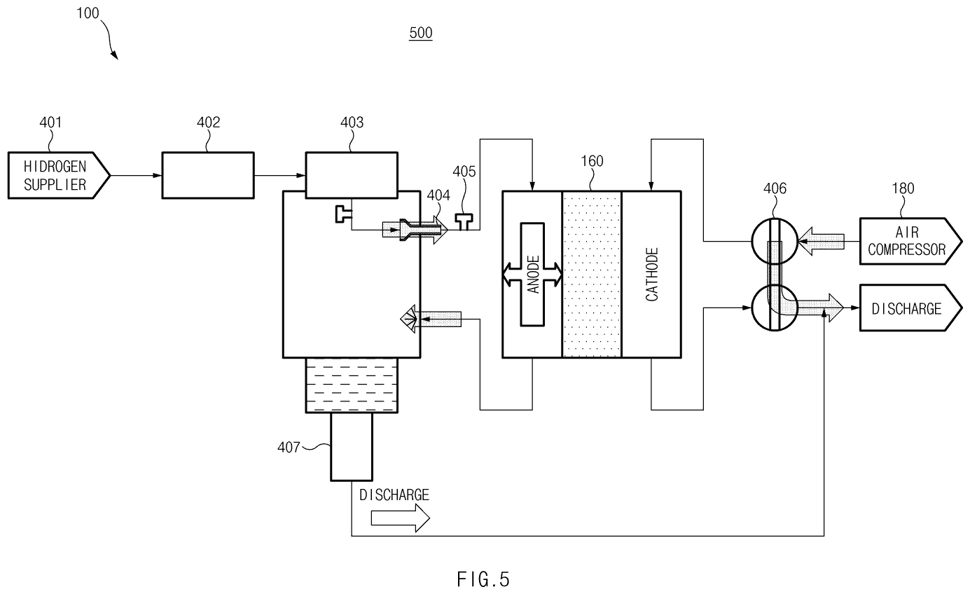

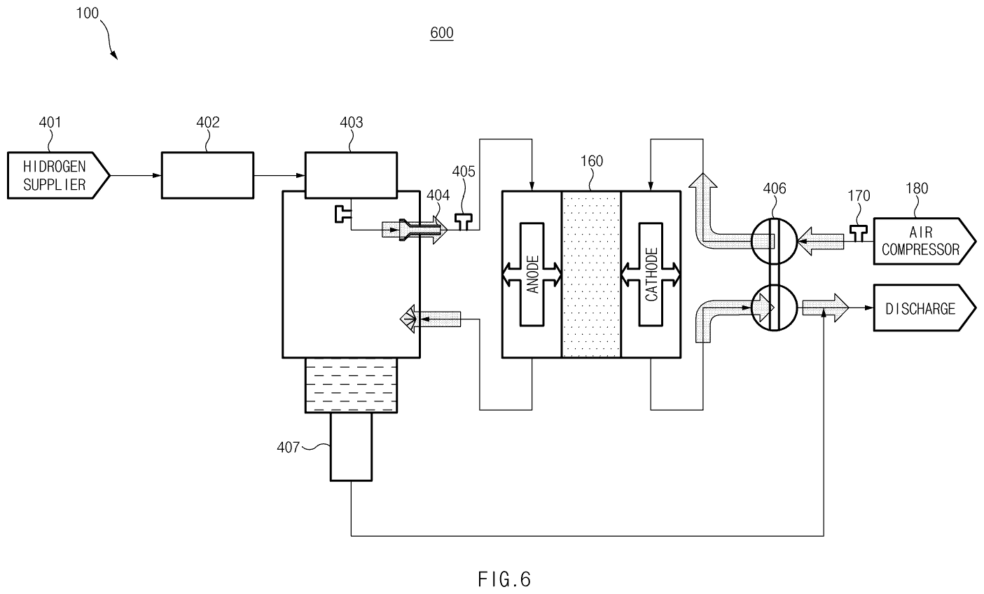

FIG. 3 shows an example of steps for the vehicle control apparatus according to an example of the present disclosure to control the fuel cell system. FIG. 4 shows an example of a state for explaining steps in which the vehicle control apparatus according to an example of the present disclosure supplies hydrogen to the fuel cell. FIG. 5 shows an example of a state for explaining steps in which the vehicle control apparatus according to an example of the present disclosure performs a starting purge. FIG. 6 shows an example of a state for explaining steps in which the vehicle control apparatus according to an example of the present disclosure supplies air to the fuel cell. The vehicle control apparatus 100 of FIGS. 3 to 6 may be referenced to the vehicle control apparatus 100 of FIG. 1.

Referring to FIG. 3, an example of graph 300 showing a sequence for the vehicle control apparatus 100 to control the fuel cell system in response to the starting-on (or ignition-on) of a vehicle is shown.

Referring to graph 300, the vehicle control apparatus 100 according to an example may enter a hydrogen supply step 310 to supply hydrogen to the fuel cell (e.g., the fuel cell 160 in FIG. 1) in response to the ignition-on of a vehicle. The step may be referred to as a process. For example, the vehicle control apparatus 100 may perform the hydrogen supply process 310 to supply hydrogen to the fuel cell.

Referring to graph 300, the vehicle control apparatus 100 according to an example may enter a bypass step 330 for a specified period of time while supplying hydrogen to the fuel cell in response to the ignition-on of a vehicle. The vehicle control apparatus 100 may block air from entering the fuel cell from the air compressor in the bypass step 330. The bypass step 330 may include a state in which air introduced into a vehicle through the air compressor is blocked from being transferred to the fuel cell.

Referring to FIG. 4, an example 400 showing the fuel cell system in the hydrogen supply step 310 and/or the bypass step 330 is shown.

Referring to FIG. 4, in the hydrogen supply step 310 and/or the bypass step 330, the vehicle control apparatus 100 may supply hydrogen from a hydrogen supplier 401 to the fuel cell 160 (e.g., anode). The vehicle control apparatus 100 may activate a fuel shutoff valve 402 and/or a fuel supply valve 403 to supply hydrogen to the fuel cell 160.

For example, activating a valve may include opening a valve. Likewise, deactivating a valve may include closing (or blocking) a valve.

The vehicle control apparatus 100 may supply (or provide) hydrogen to the fuel cell 160 by using a fuel ejector 404 and/or a fuel pressor 405 based on the activation of the fuel shutoff valve 402 and/or the fuel supply valve 403.

Referring to FIG. 4, in the hydrogen supply step 310 and/or the bypass step 330, the vehicle control apparatus 100 may inject air into a vehicle from the outside of the vehicle through the air compressor 180 while supplying hydrogen to the fuel cell 160. The vehicle control apparatus 100 may block air from being supplied to the fuel cell 160 (e.g., a cathode) if an air control valve 406 is closed.

Referring back to FIG. 3, the vehicle control apparatus 100 according to an example may enter a starting purge step 320 to secure hydrogen concentration in the anode of the fuel cell 160. The vehicle control apparatus 100 may perform the bypass step 330 to satisfy a hydrogen concentration regulation. However, the present disclosure is not limited thereto.

Referring to FIG. 5, an example 500 showing the fuel cell system in the starting purge step 320 is shown. In the starting purge step 320, the vehicle control apparatus 100 according to an example may discharge gas within the fuel cell 160 (e.g., an anode) to the outside by activating a fuel discharge valve 407. For example, the vehicle control apparatus 100 may discharge other gases distinct from hydrogen to the outside from the fuel cell 160 while blocking air from entering the fuel cell 160 from the air compressor 180. However, the present disclosure is not limited thereto. As an example, other gases may include hydrogen, air, oxygen, and/or nitrogen.

In an example, the vehicle control apparatus 100 may diagnose flow oscillation for each RPM (revolutions per minute) of the air compressor in a specific sequence step during the starting of a vehicle during a predetermined drive cycle after a power module complete (PMC) (e.g., a fuel cell system) is first installed in a vehicle.

For example, the RPM of the air compressor may be changed depending on the drive cycle. For example, during first starting, the vehicle control apparatus 100 may diagnose air flow oscillation by driving the air compressor 180 based on a first RPM (e.g., 15000 RPM). For example, during second starting, the vehicle control apparatus 100 may diagnose air flow oscillation by driving the air compressor 180 based on a second RPM (e.g., 20000 RPM). However, the present disclosure is not limited thereto.

The vehicle control apparatus 100 according to an example may drive the air compressor 180 based on specified revolutions per minute (RPM) while blocking air from entering the fuel cell from the air compressor (e.g., the bypass step 330) in response to an input indicating the ignition-on of a vehicle. The specified RPM may be determined, based on a mapping table that represents a relationship between a flow used to drive the vehicle and the RPM of the air compressor.

The vehicle control apparatus 100 according to an example may identify, through the sensor, whether the flow of air flowing into a vehicle from the outside exceeds a target flow based on driving the air compressor by fixing the specified RPM.

For example, the vehicle control apparatus 100 may identify that the flow of air flowing into a vehicle does not exceed a target flow if the flow of air flowing into the vehicle is within a specified flow range including the target flow.

For example, the vehicle control apparatus 100 may identify that the flow of air flowing into a vehicle exceeds a target flow if the flow of air flowing into the vehicle is outside a specified flow range including the target flow.

In an example, the vehicle control apparatus 100 may identify the oscillation of an air flow by using the sensor, and thus may identify that the air flow is outside a specified flow range (e.g., the air flow exceeds the target flow) due to the oscillation of the air flow.

The vehicle control apparatus 100 according to an example may change a parameter to reduce the oscillation of the output of a vehicle, which corresponds to a specified RPM, if the flow of air flowing into the vehicle from the outside exceeds a target flow.

Referring back to FIG. 3, the vehicle control apparatus 100 according to an example may enter an air supply step 340 to supply air to the fuel cell 160 after performing the starting purge step 320 (or a starting purge process). After entering the air supply step 340, the vehicle control apparatus 100 may enter a starting completion step 350, which indicates that the starting of the vehicle is completed.

Referring to FIG. 6, an example 600 showing the fuel cell system in the air supply step 340 and/or the starting completion step 350 is shown.

Referring to FIG. 6, the vehicle control apparatus 100 may supply air to the cathode of the fuel cell 160 through the air compressor 180 while supplying hydrogen to the anode of the fuel cell 160 through the hydrogen supplier 401. For example, the vehicle control apparatus 100 may supply air to the cathode of the fuel cell 160 by activating the air control valve 406 based on completion of starting. The vehicle control apparatus 100 may measure the flow of air flowing into the fuel cell through the sensor 170.

The vehicle control apparatus 100 according to an example may identify the output of a vehicle corresponding to a specified RPM after the starting of the vehicle is completed. The vehicle control apparatus 100 may identify the output of the vehicle corresponding to the specified RPM while the vehicle is running the starting of the vehicle is completed. The vehicle control apparatus 100 may identify whether the output of the vehicle is within a specified output range. The specified output range may include the error range of the output of a vehicle in the normal state of the air intake system. The vehicle control apparatus 100 may identify the specified output range according to the specified RPM by using a mapping table representing a relationship between the specified output range and the specified RPM.

The vehicle control apparatus 100 according to an example as described above may identify that there is no abnormality in the output of a vehicle using a changed parameter if the output of the vehicle corresponding to the specified RPM is within the specified output range. In other words, the vehicle control apparatus 100 may identify that the oscillation of the output of the vehicle using the changed parameter is within an error range. The vehicle control apparatus 100 may control the vehicle more stably by using the changed parameter.

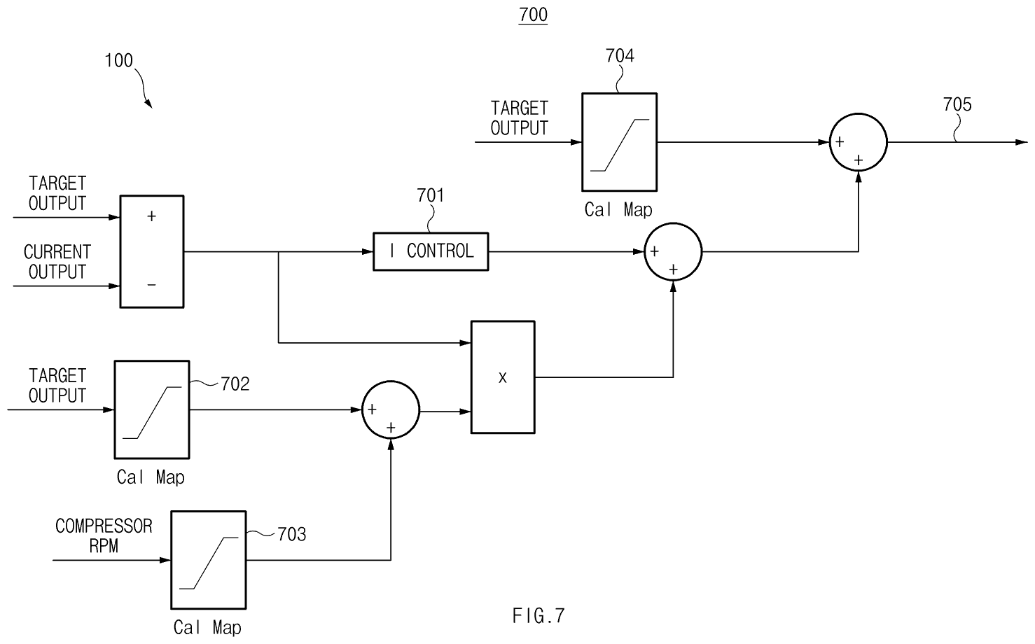

FIG. 7 shows an example of a flowchart for explaining an operation in which the vehicle control apparatus according to an example of the present disclosure changes a parameter. The vehicle control apparatus 100 of FIG. 7 may be reference to the vehicle control apparatus 100 of FIG. 1.

Referring to FIG. 7, in an example 700, the vehicle control apparatus 100 may obtain the output of a vehicle based on the fuel cell by using the PI controller.

In an example, the vehicle control apparatus 100 may identify a target output (or a used output) for driving a vehicle and a current output obtained from the fuel cell. For example, the vehicle control apparatus 100 may perform ‘I’ control 701 by determining the target output and the current output.

In an example, by determining the target output, the vehicle control apparatus 100 may identify a parameter (e.g., ‘P’ control parameter) corresponding to the target output. The vehicle control apparatus 100 may identify a parameter corresponding to the target output by using a mapping table 702 (e.g., calibration map) representing ‘P’ control gain for each target output.

The vehicle control apparatus 100 according to an example may identify the flow of air flowing into a vehicle from the outside of the vehicle based on the RPM of the air compressor in response to the ignition-on of the vehicle. For example, the air flow may exceed a target flow (or a specified flow range).

For example, if the air flow exceeds the target flow, the vehicle control apparatus 100 may compensate for a parameter. The vehicle control apparatus 100 may change (or compensate for) the parameter by using a mapping table 703 that shows a compensation value (e.g., −0.1) of the parameter for each RPM of the air compressor.

In an example, the vehicle control apparatus 100 may obtain an output 705 of a vehicle by using the changed parameter and another parameter resulting from performing the ‘I’ control 701. The output 705 of the vehicle may include a voltage to be obtained through the fuel cell system. The voltage may be obtained through the converter 210 of FIG. 2. The vehicle control apparatus 100 may control a vehicle by outputting a voltage corresponding to the output 705 from the fuel cell (or the converter) by using the changed parameter.

For example, the vehicle control apparatus 100 may identify a current to be output from the fuel cell by using the PI controller. The vehicle control apparatus 100 may identify a current to be output from the fuel cell by compensating for a parameter by using the PI controller. The vehicle control apparatus 100 may obtain a target voltage for obtaining the output 705 of a vehicle by using a mapping table 704 representing a current-voltage characteristic curve by determining a current to be output from the fuel cell and a target output. For example, the vehicle control apparatus 100 may drive the vehicle by controlling the motor (e.g., the motor 240 in FIG. 2) by using the target voltage.

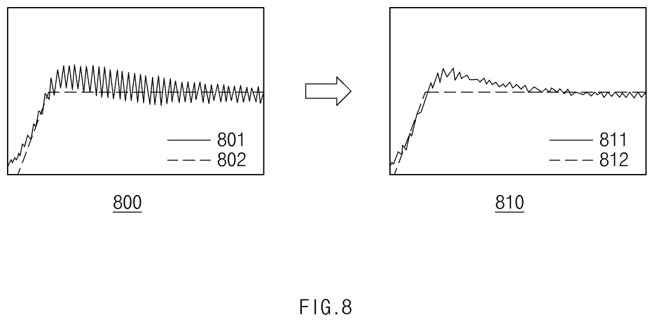

FIG. 8 shows an example of a graph representing the output of a vehicle identified by the vehicle control apparatus according to an example of the present disclosure changing a parameter. The vehicle control apparatus 100 according to an example may identify the output of a vehicle through the sensor. Graph 800 may include the output of a vehicle identified before the vehicle control apparatus 100 changes a parameter associated with the PI controller in response to ignition-on of the vehicle. Graph 810 may include the output of a vehicle identified after the vehicle control apparatus 100 changes a parameter related to the PI controller in response to the ignition-on of the vehicle.

For example, graph 800 may include a graph representing a target output 802 based on the specified RPM of the air compressor and a graph representing an actual output 801 of a vehicle identified through the sensor.

The vehicle control apparatus 100 according to an example may drive the air compressor 180 based on specified revolutions per minute (RPM) while blocking air from entering the fuel cell from the air compressor in response to an input indicating the ignition-on of a vehicle. The vehicle control apparatus 100 may identify, through the sensor, whether the flow of air flowing into the vehicle from the outside exceeds a target flow based on the driving of the air compressor. The vehicle control apparatus 100 may change a parameter to reduce oscillation of the output of the vehicle, which corresponds to a specified RPM, if the flow of air flowing into the vehicle from the outside exceeds the target flow.

The vehicle control apparatus 100 according to an example may identify the output of a vehicle corresponding to the specified RPM after starting of the vehicle is completed. The vehicle control apparatus 100 may identify whether the output of the vehicle is within a specified output range. The vehicle control apparatus 100 may control the vehicle by using the changed parameter if the output of the vehicle corresponding to the specified RPM is within the specified output range.

For example, graph 810 may include a graph representing an actual output 812 of the vehicle identified by using the changed parameter and a graph representing a target output 811 of the vehicle corresponding to the specified RPM.

Referring to graph 800 and graph 810, it may be seen that the oscillation of the actual output 811 of a vehicle included in graph 810 is relatively reduced compared to the oscillation of the actual output 801 of the vehicle included in graph 800. The vehicle control apparatus 100 may control the vehicle more stably by changing a parameter to reduce oscillation.

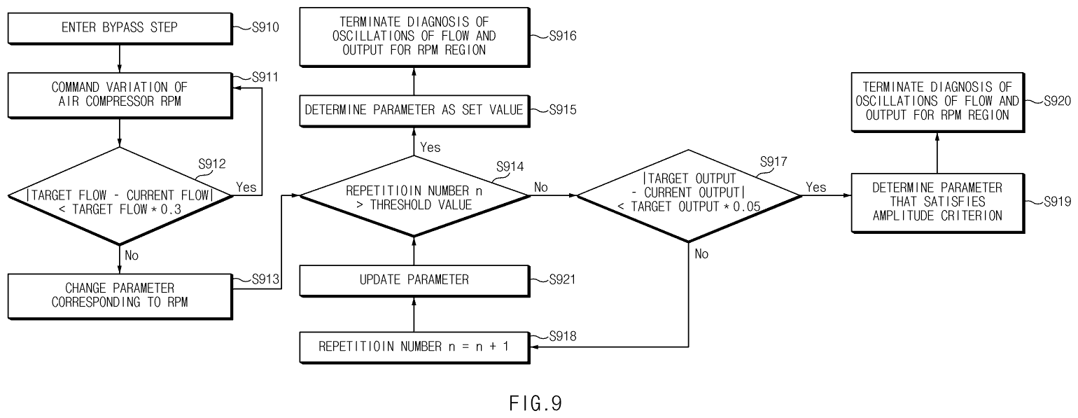

FIG. 9 shows an example of a flowchart representing the operation of the vehicle control apparatus according to an example of the present disclosure. Hereinafter, it is assumed that the vehicle control apparatus 100 of FIG. 1 performs the process of FIG. 9. Additionally, in the description of FIG. 9, operations described as being performed by an apparatus may be understood as being controlled by the processor 110 of the vehicle control apparatus 100. Each of the operations in FIG. 9 may be performed sequentially, but is not necessarily performed sequentially. For example, the order of each of the operations may be changed, and at least two operations may be performed in parallel.

Referring to FIG. 9, in operation S910, the vehicle control apparatus according to an example may enter the bypass step (e.g., the bypass step 330 in FIG. 3) in response to the ignition-on of a vehicle.

Referring to FIG. 9, in operation S911, the vehicle control apparatus according to an example may perform variation of the RPM of the air compressor for each drive cycle. For example, the vehicle control apparatus may drive the air compressor based on a specified RPM.

Referring to FIG. 9, in operation S912, the vehicle control apparatus according to an example may identify whether the flow of air introduced into the vehicle is within a specified flow range based on the operation of the air compressor. For example, the vehicle control apparatus may identify whether a difference between a target flow corresponding to the specified RPM and the actual flow of air introduced into the vehicle is less than the target flow multiplied by a specified value (e.g., approximately 0.03).

For example, if the flow of air introduced into the vehicle is within the specified flow range (operation S912—Yes), the vehicle control apparatus may identify that the oscillation of the air flow corresponding to the specified RPM is in a stable range. For example, if the flow of air introduced into the vehicle is within the specified flow range (operation S912—Yes), the vehicle control apparatus may perform operation S912 by driving the air compressor based on an RPM different from the specified RPM.

Referring to FIG. 9, if the flow of air introduced into the vehicle is not within the specified flow range (operation S912—No), in operation S913, the vehicle control apparatus according to an example may change a parameter corresponding to the specified RPM (e.g., a ‘P’ control parameter). The vehicle control apparatus according to an example may compensate for the parameter corresponding to the specified RPM by −0.1. For example, the vehicle control apparatus 100 may identify that the oscillation of the flow of air corresponding to the specified RPM is in an unstable range if the flow of air introduced into the vehicle is not within the specified flow range (operation S912—No). Since the oscillation of the air flow corresponding to the specified RPM is in the unstable range, the vehicle control apparatus may change a parameter to compensate for the output of the vehicle.

The vehicle control apparatus according to an example may identify a parameter corresponding to the specified RPM by using a mapping table. For example, the vehicle control apparatus may change a parameter if the flow of air flowing into the vehicle from the outside exceeds a target flow.

Referring to FIG. 9, in operation S914, the vehicle control apparatus according to an example may check whether the number of parameter changes (e.g., the number n of repetitions in FIG. 9) exceeds a threshold value (e.g., about 3 or 4 times).

Referring to FIG. 9, the vehicle control apparatus according to an example may check whether the output of a vehicle obtained based on a specified RPM is within a specified output range in operation S917 if the number of the parameter changes is less than the threshold value (operation S914—No).

For example, the vehicle control apparatus may perform operation S917 after the starting of the vehicle is completed.

For example, checking whether the output of the vehicle is within the specified output range may include checking whether a difference between a target output corresponding to the specified RPM and a current output is less than the target output multiplied by a specified value (e.g., 0.05).

Referring to FIG. 9, if the output of the vehicle obtained based on the specified RPM is within the specified output range (operation S917—Yes), a parameter that satisfies an amplitude criterion may be determined in operation S919. The parameter that satisfies the amplitude criterion may include the parameter changed in operation S913. By using the changed parameter, an output obtained by the vehicle control apparatus may be expressed visually as the output 811 in FIG. 8.

Referring to FIG. 9, in operation S920, based on the determination of the parameter, the diagnosis for determining the oscillations of a flow and an output for a region including the specified RPM may end. However, the present disclosure is not limited thereto.

Referring to FIG. 9, if the output of the vehicle obtained based on the specified RPM is outside the specified output range (operation S917—No), the vehicle control apparatus according to an example may increase the number of repetitions in operation S918. For example, the output of the vehicle obtained based on the specified RPM being outside the specified output range may include at least one value representing the output of the vehicle being outside the specified output range.

For example, the vehicle control apparatus may iteratively further reduce a parameter based on a specified number of times if the output of the vehicle is outside the specified output range.

For example, the vehicle control apparatus may perform operation S921 based on increasing the number of repetitions. The vehicle control apparatus may update the parameter by performing operation S921 based on increasing the number of repetitions. For example, the vehicle control apparatus may compensate for the value of the parameter. For example, the vehicle control apparatus may further reduce the value of the parameter.

Referring to FIG. 9, in operation S914, the vehicle control apparatus according to an example may check whether the number of parameter changes (e.g., the number n of repetitions in FIG. 9) exceeds a threshold value (e.g., about 3 or 4 times). Referring to FIG. 9, if the number of parameter changes (e.g., the number n of repetitions in FIG. 9) exceeds the threshold valued (e.g., about 3 or 4 times) (operation $914-Yes), the vehicle control apparatus according to an example may determine a parameter as a set value in operation S915.

For example, since repeatedly changing a parameter (or repeatedly reducing a parameter value) may affect the performance of a vehicle, the vehicle control apparatus may determine a parameter as a set value. The set value may include a minimum value not to affect the performance of a vehicle.

Referring to FIG. 9, in operation S916, the vehicle control apparatus according to an example may terminate the diagnosis of the oscillations of a flow and an output for a region including the specified RPM. For example, the vehicle control apparatus may obtain the output of a vehicle by using a changed parameter based on terminating the diagnosis of the oscillations of a flow and an output. The vehicle control apparatus may drive the vehicle according to the output of the vehicle by obtaining the output of the vehicle by using the changed parameter.

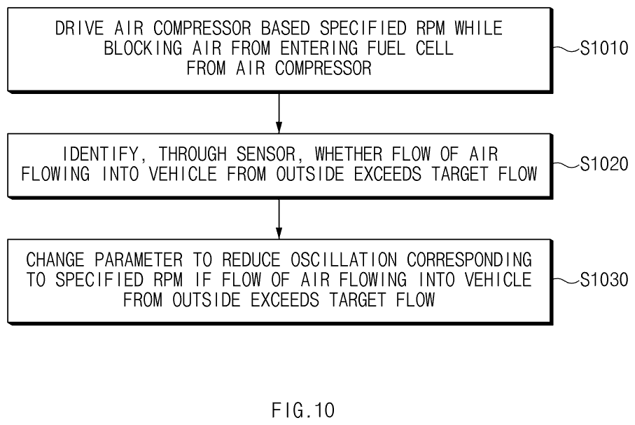

FIG. 10 shows an example of a flowchart representing a vehicle control method according to an example of the present disclosure. Hereinafter, it is assumed that the vehicle control apparatus 100 of FIG. 1 performs the process of FIG. 10. In addition, in the description of FIG. 10, operations described as being performed by an apparatus may be understood as being controlled by the processor 110 of the vehicle control apparatus 100. Each of the operations in FIG. 10 may be performed sequentially, but is not necessarily performed sequentially. For example, the order of each of the operations may be changed, and at least two operations may be performed in parallel.

Referring to FIG. 10, in operation S1010, the vehicle control apparatus according to an example may drive the air compressor based the specified RPM while blocking air from entering the fuel cell from the air compressor (e.g., in the bypass step 330 in FIG. 3). For example, the vehicle control apparatus may drive the air compressor based on the specified RPM in response to determining the ignition-on of a vehicle. The vehicle control apparatus may drive the air compressor based on the specified RPM according to a drive cycle.

Referring to FIG. 10, in operation S1020, the vehicle control apparatus according to an example may identify, through the sensor, whether the flow of air flowing into a vehicle from the outside exceeds a target flow.

For example, the vehicle control apparatus may identify that the air flow corresponding to a specified RPM does not cause the oscillation of the output of a vehicle if the air flow does not exceed the target flow.

For example, the vehicle control apparatus may repeatedly perform operations to diagnose the oscillation of an output by driving the air compressor based on another RPM distinct from the specified RPM if the air flow does not exceed the target flow. The number of repetitions of the operations may be preset. However, the present disclosure is not limited thereto.

Referring to FIG. 10, in operation S1030, the vehicle control apparatus according to an example may change (or may reduce) a parameter to reduce the oscillation of the output of the vehicle, which corresponds to a specified RPM, if the flow of air flowing into the vehicle from the outside exceeds the target flow. The parameter may be determined by using an error between the target output of the vehicle corresponding to the specified RPM and a current output obtained through the fuel cell. The vehicle control apparatus may manage the output of the vehicle more stably by changing a parameter.

The vehicle control apparatus according to an example as described above may change a parameter to reduce the oscillation of the output of the vehicle by determining the ignition-on of a vehicle independently of the execution of a diagnostic mode for diagnosing an output, thereby reducing the oscillation of the output of the vehicle.

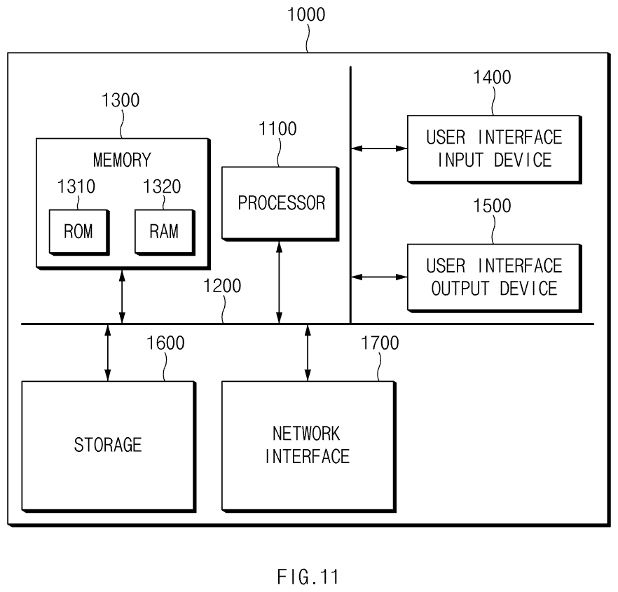

FIG. 11 shows an example of a computing system related to the vehicle control apparatus or the vehicle control method according to an example of the present disclosure.

Referring to FIG. 11, The computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the examples disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The present disclosure has been made to solve the above-mentioned problems occurring in the prior art while advantages achieved by the prior art are maintained intact.

An example of the present disclosure provides an apparatus for vehicle control and a method thereof for diagnosing the oscillation of the output of a vehicle.

An example of the present disclosure provides an apparatus for vehicle control and a method thereof for correcting the oscillation of the output of a vehicle independently of execution of a diagnostic mode.

An example of the present disclosure provides an apparatus for vehicle control and a method thereof for diagnosing the oscillation of a flow during vehicle starting sequence.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus according to an example of the present disclosure includes a processor, a memory, a fuel cell, a sensor, and an air compressor. The processor drives the air compressor based on a specified revolutions per minute (RPM) while blocking air from entering the fuel cell from the air compressor in response to an input indicating that ignition of a vehicle is on, identifies, through the sensor, whether a flow of air flowing into the vehicle from an outside is within a specified flow range including a target flow, based on the driving of the air compressor, and changes a parameter to reduce an oscillation of an output of the vehicle, which corresponds to the specified RPM, if the flow of the air flowing into the vehicle from the outside is outside the specified flow range.

In an example, the processor may further identify the output of the vehicle corresponding to the specified RPM after the ignition of the vehicle is completed, identify whether the output of the vehicle is within a specified output range, change the parameter if the output of the vehicle corresponding to the specified RPM is outside the specified output range, and control the vehicle by using the changed parameter.

In an example, the processor may further stop the changing of the parameter if the output of the vehicle corresponding to the specified RPM is within the specified output range.

In an example, the processor may further set the parameter to a minimum value for minimizing the oscillation of the output if the output of the vehicle is outside the specified output range.

In an example, the processor may further control the vehicle by outputting a voltage corresponding to the output from the fuel cell by using the changed parameter.

In an example, the processor may further drive the air compressor, based on a different specified RPM distinct from the specified RPM if the flow of the air flowing into the vehicle is within the specified flow range.

In an example, the processor may further control the air to be prevented from flowing into the fuel cell through an air bypass.

In an example, the processor may further identify the parameter corresponding to the specified RPM, and change the parameter if the flow of the air flowing into the vehicle from the outside is outside the specified flow range.

In an example, the processor may further supply hydrogen to the fuel cell in the state where the air from the air compressor is blocked from entering the fuel cell.

In an example, the parameter may represent a relationship between the output of the vehicle and a voltage of the fuel cell to generate the output of the vehicle.

According to another example of the present disclosure, a vehicle control method according to an example includes driving an air compressor based on a specified RPM (revolutions per minute) while blocking air from entering a fuel cell from the air compressor in response to an input indicating that ignition of a vehicle is on, determining, through a sensor, whether a flow of air flowing into the vehicle from an outside is within a specified flow range including a target flow, based on the driving of the air compressor, and changing a parameter to reduce an oscillation of an output of the vehicle, which corresponds to the specified RPM, if the flow of the air flowing into the vehicle from the outside is outside the specified flow range.

In an example, the changing of the parameter may include determining the output of the vehicle corresponding to the specified RPM after the ignition of the vehicle is completed, determining whether the output of the vehicle is within a specified output range, changing the parameter if the output of the vehicle corresponding to the specified RPM is outside the specified output range, and controlling the vehicle by using the changed parameter.

In an example, the determining of whether the output of the vehicle is within the specified output range may include stopping the changing of the parameter if the output of the vehicle corresponding to the specified RPM is within the specified output range.

In an example, the determining of whether the output of the vehicle is within the specified output range may include setting the parameter to a minimum value for minimizing the oscillation of the output if the output of the vehicle is outside the specified output range.

In an example, the controlling of the vehicle may include controlling the vehicle by outputting a voltage corresponding to the output from the fuel cell by using the changed parameter.

In an example, the determining of whether the flow of the air flowing into the vehicle is within the specified flow range may include driving the air compressor, based on a different specified RPM distinct from the specified RPM if the flow of the air flowing into the vehicle is within the specified flow range.

In an example, the driving of the air compressor may include controlling the air to be prevented from flowing into the fuel cell through an air bypass.

In an example, the changing of the parameter may include determining the parameter corresponding to the specified RPM, and changing the parameter if the flow of the air flowing into the vehicle from the outside is outside the specified flow range.

In an example, the driving of the air compressor may include supplying hydrogen to the fuel cell in the blocking of the air from entering the fuel cell from the air compressor.

In an example, the parameter may represent a relationship between the output of the vehicle and a voltage of the fuel cell to generate the output of the vehicle.

The above explanation is merely an exemplary explanation of the technical idea of the present disclosure, and those skilled in the art in the technical field to which the present disclosure belongs may make various modifications and variations without departing from the characteristics of the present disclosure.

Accordingly, the examples disclosed in the present disclosure are not intended to limit but explain the technical idea of the present disclosure, and the scope of the technical idea of the present disclosure is not limited by these examples. The scope of protection of the present disclosure should be interpreted in accordance with the claims below, and all technical ideas within a scope equivalent thereto should be interpreted as being included in the scope of rights of the present disclosure.

This technology may diagnose the oscillation of the output of a vehicle.

This technology may correct the oscillation of the output of a vehicle independently of the execution of a diagnostic mode.

In addition, this technology may diagnose the oscillation of a flow during vehicle starting sequence.

In addition, various effects that are directly or indirectly identified through this document may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a fuel cell;
a sensor;
an air compressor; and
a processor configured to:
drive, based on an input indicating that the vehicle's ignition is on, the air compressor at a specified revolutions per minute (RPM) and control an air flow to prevent from entering the fuel cell;
determine, based on sensor information from the sensor, whether a flow of air, driven by the air compressor, entering the vehicle from an outside is within a specified flow range, wherein the specified flow range comprises a target flow; and
change, based on the flow of the air entering the vehicle being outside the specified flow range, a parameter to adjust an oscillation of an output of the vehicle, wherein the output of the vehicle corresponds to the specified RPM.

2. The apparatus of claim 1, wherein the processor is further configured to:
after the vehicle's ignition is completed, determine the output of the vehicle;
determine whether the output of the vehicle is within a specified output range;
change, based on the output of the vehicle being outside the specified output range, the parameter; and
control, based on the changed parameter, the vehicle.

3. The apparatus of claim 2, wherein the processor is further configured to stop, based on the output of the vehicle being within the specified output range, changing the parameter.

4. The apparatus of claim 2, wherein the processor is further configured to set, based on the output of the vehicle being outside the specified output range, the parameter to a minimum value for minimizing the oscillation.

5. The apparatus of claim 1, wherein the processor is further configured to control the vehicle by outputting, based on the changed parameter, a voltage corresponding to the output from the fuel cell.

6. The apparatus of claim 1, wherein the processor is further configured to drive, based on the flow of the air entering the vehicle being within the specified flow range, the air compressor at another RPM different from the specified RPM.

7. The apparatus of claim 1, wherein the processor is further configured to control the air to be prevented from entering the fuel cell through an air bypass.

8. The apparatus of claim 1, wherein the processor is further configured to:
determine the parameter, wherein the parameter corresponds to the specified RPM; and
change, based on the flow of the air being outside the specified flow range, the parameter.

9. The apparatus of claim 1, wherein the processor is further configured to supply hydrogen to the fuel cell in the state where air from the air compressor is blocked from entering the fuel cell.

10. The apparatus of claim 1, wherein the parameter represents a relationship between the output of the vehicle and a voltage of the fuel cell, wherein the voltage is applied to generate the output of the vehicle.

11. A method performed by an apparatus for controlling a vehicle, the method comprising:
driving, based on an input indicating that the vehicle's ignition is on, an air compressor at a specified revolutions per minute (RPM) and controlling an air flow to prevent from entering a fuel cell;
determining, based on sensor information from a sensor, whether a flow of air entering the vehicle from an outside is within a specified flow range, wherein the specified flow range comprises a target flow; and
changing, based on the flow of the air entering the vehicle being outside the specified flow range, a parameter to adjust an oscillation of an output of the vehicle, wherein the output of the vehicle corresponds to the specified RPM.

12. The method of claim 11, wherein the changing of the parameter comprises:
after the vehicle's ignition is completed, determining the output of the vehicle;
determining whether the output of the vehicle is within a specified output range;
changing, based on the output of the vehicle being outside the specified output range, the parameter; and
controlling, based on the changed parameter, the vehicle.

13. The method of claim 12, wherein the determining whether the output of the vehicle is within the specified output range comprises stopping, based on the output of the vehicle being within the specified output range, changing the parameter.

14. The method of claim 12, wherein the determining whether the output of the vehicle is within the specified output range comprises setting, based on the output of the vehicle being outside the specified output range, the parameter to a minimum value for minimizing the oscillation.

15. The method of claim 12, wherein the controlling the vehicle comprises controlling the vehicle by outputting, based on the changed parameter, a voltage corresponding to the output from the fuel cell.

16. The method of claim 11, wherein the determining whether the flow of the air flowing into the vehicle is within the specified flow range comprises driving, based on the flow of the air entering the vehicle being within the specified flow range, the air compressor at another RPM different from the specified RPM.

17. The method of claim 11, wherein the driving the air compressor comprises controlling the air to be prevented from entering the fuel cell through an air bypass.

18. The method of claim 11, wherein the changing the parameter comprises:
determining the parameter, wherein the parameter corresponds to the specified RPM; and
changing, based on the flow of the air entering the vehicle being outside the specified flow range, the parameter.

19. The method of claim 11, wherein the driving the air compressor comprises supplying hydrogen to the fuel cell in a state where air from the air compressor being blocked from entering the fuel cell.

20. The method of claim 11, wherein the parameter represents a relationship between the output of the vehicle and a voltage of the fuel cell, wherein the voltage is applied to generate the output of the vehicle.
